(19) United States
(12) Patent Application Publication
(10) Pub. No.: US 2025/0267691 A1
(43) Pub. Date: Aug. 21, 2025

(54) BANDWIDTH COMBINATION SET FALLBACK SIGNALLING

(71) Applicant: T-MOBILE INNOVATIONS LLC, Overland Park, KS (US)

(72) Inventors: William M. SHVODIAN, McLean, VA (US); Hui-Hsia SUNG, Bellevue, WA (US)

(21) Appl. No.: 19/057,784

(22) Filed: Feb. 19, 2025

Related U.S. Application Data
(60) Provisional application No. 63/555,395, filed on Feb. 19, 2024.

(51) Int. Cl. H04W 72/51; H04L 5/00; H04W 72/0457

(52) U.S. Cl. CPC H04W 72/51; H04L 5/001; H04W 72/0457

(57) ABSTRACT

A system and method for signaling fallback bandwidth combination set (BCS) values in a wireless communication network are disclosed. A user equipment (UE) transmits a capability message comprising a primary BCS value and at least one fallback BCS value to a base station. The fallback BCS signaling may be persistent or triggered based on network conditions, such as roaming or a lack of BCS support from the base station. The fallback BCS values may be transmitted within the same message as the primary BCS value or in a separate message, either as a second feature set or an independent message. This approach enhances carrier aggregation adaptability and ensures optimal network performance. The described techniques apply to cellular networks and other wireless technologies, such as Wi-Fi multi-link operation (MLO).

### CROSS-REFERENCE TO RELATED APPLICATIONS

This application claims the benefit of U.S. Provisional Patent Application No. 63/555,395, filed on Feb. 19, 2024 the entirety of which is incorporated herein by reference.

### SUMMARY

The present disclosure is directed to user equipment (UE) signaling bandwidth combination fallback capabilities, substantially as shown and/or described in connection with at least one of the Figures, and as set forth more completely in the claims.

In modern communication environments, UEs are often capable of aggregating two or more component carriers in order to achieve higher throughput. In 5G, information about the specific carrier aggregation capabilities of the UE is accomplished by reporting its bandwidth combination set (BCS) capabilities to a radio access network (RAN) node. Variations in network support for BCS values can lead to interoperability issues, limiting optimal CA configurations. To address this, the disclosure introduces fallback BCS signaling, enabling user equipment (UE) to transmit both a primary BCS value and one or more fallback BCS values to a base station. This signaling may be persistent or triggered by conditions such as roaming, an absence of BCS support from the base station, or explicit network indications. Fallback BCS values may be included in the same message as the primary BCS value or sent separately as a second feature set or an independent message. This flexibility allows UEs to maintain CA across networks with varying BCS support. Additionally, fallback band combination capabilities may be signaled, either as a strict subset of primary capabilities or as an alternative configuration optimized for fallback BCS values.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 illustrates a diagram of an exemplary environment in which implementations of the present disclosure may be employed; and

FIG. 3 depicts a flow diagram of an exemplary method for reporting aggregated bandwidth capability of a UE in a carrier aggregation session, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, wireless communication networks, such as those operating under the Fifth Generation (5G) New Radio (NR) standard, support carrier aggregation (CA) to enhance data throughput by combining multiple component carriers. To facilitate CA, user equipment (UE) reports one or more bandwidth combination set (BCS) index to indicate its supported aggregation configurations. The network, upon receiving this information, determines the appropriate CA configuration based on the reported BCS index or indexes. The BCS indexes are referenced against predefined sets of component carrier bandwidths and frequency bands specified in 3GPP technical standards. Because different BCS indexes define different aggregation possibilities, the successful configuration of CA depends on the network's ability to interpret and apply the reported BCS indexes.

Conventionally, a UE signals its capability information during initial registration or when requested by the network. This capability signaling typically includes one or more feature sets, each of which defines a set of supported radio parameters, including MIMO configurations, modulation schemes, power class settings, and a single BCS index. Alongside the feature set, the UE also reports its supported band combinations, which specify the frequency bands and bandwidths the UE can use for CA. When configuring CA, the network selects a feature set and applies the corresponding BCS indexes to determine the valid aggregation configurations. However, a significant limitation of current BCS signaling is that a if a UE only reports one BCS index per feature set, meaning that if a UE reports support only for a single BCS and the network node does not support the reported BCS index, it cannot interpret or apply any of the UE's carrier aggregation capabilities including the fallbacks. As a result, the network may either fall back to single-carrier operation or attempt to use an alternative combination or feature set, which may unnecessarily alter other parameters unrelated to BCS, such as modulation schemes or power settings. Since only BCSs for the highest order combinations are usually transmitted and the fallbacks are implied, if the network does not support the reported BCS index, then there may be inefficient spectrum utilization, degraded network performance, and CA failures in scenarios where the UE and network otherwise support a common aggregation configuration.

Unlike conventional solutions, the present disclosure is directed to systems and methods for signaling fallback bandwidth combination set information. In some embodiments, a UE may be configured to report both a primary BCS index and at least one fallback BCS index. By doing so, a network node that does not support the primary BCS index may instead select a fallback BCS index without requiring a full feature set transition, thereby preserving compatibility while avoiding unnecessary adjustments to other network parameters. In some implementations, fallback BCS indexes may be signaled using an extension to existing UE capability information messages or through a new dedicated signaling structure that allows dynamic selection of an alternative BCS based on network support. By enabling multi-index BCS reporting within a single feature set, the disclosed approach enhances flexibility in CA negotiation, reduces signaling overhead, and improves system performance by ensuring that BCS mismatches do not lead to complete loss of CA capabilities.

Accordingly, a first aspect of the present disclosure is directed to a method for signaling carrier aggregation capabilities in a wireless communication network. The method comprises determining, by a UE, that a trigger condition for signaling one or more fallback bandwidth combination set (BCS) parameters is satisfied. The method further comprises responsive to determining that the trigger condition is satisfied, transmitting, by the UE, a fallback capability message comprising a primary BCS value, one or more primary band combination capabilities, and a fallback BCS value, wherein the fallback BCS value is different than the primary BCS value.

Another aspect of the present disclosure is directed to a method for signaling carrier aggregation capabilities in a wireless communication network. The method comprises determining a maximum resource block baseband processing capability of the UE. The method further comprises reporting a primary carrier aggregation capability having a first set of band combinations and a first bandwidth combination set (BCS) value. The method further comprises reporting at least one fallback carrier aggregation capability, wherein the at least one fallback carrier aggregation capability comprises a second BCS value, the second BCS value being different than the first bandwidth combination set value.

Another aspect of the present disclosure is directed to a system for reporting maximum supported bandwidth from a UE to a radio access network. The system comprises one or more antennas configured to wirelessly communicate with a base station of a radio access network. The system further comprises one or more computer processing components configured to perform operations. The operations comprise transmitting, via the one or more antennas, a highest-order bandwidth combination set (BCS) value. The operations further comprise transmitting, via the one or more antennas, at least one band combination capability. The operations further comprise transmitting, via the one or more antennas, a fallback BCS value, wherein the fallback BCS value is different than the primary BCS value.

Another aspect of the present disclosure is directed to a system for reporting maximum supported bandwidth from a UE to a radio access network. The system comprises one or more antennas configured to wirelessly communicate with a base station of a radio access network. The system further comprises one or more computer processing components configured to perform operations that effectuate the reporting of bandwidth combination set fallback information. The operations comprise determining a maximum resource block baseband processing capability of the UE. The operations further comprise reporting a highest order component carrier configuration having a first set of frequencies and a first bandwidth combination set value. The operations further comprise reporting at least one fallback component carrier configuration, wherein the at least one fallback component carrier configuration comprises a second bandwidth combination set value, the second bandwidth combination set value being different than the first bandwidth combination set value.

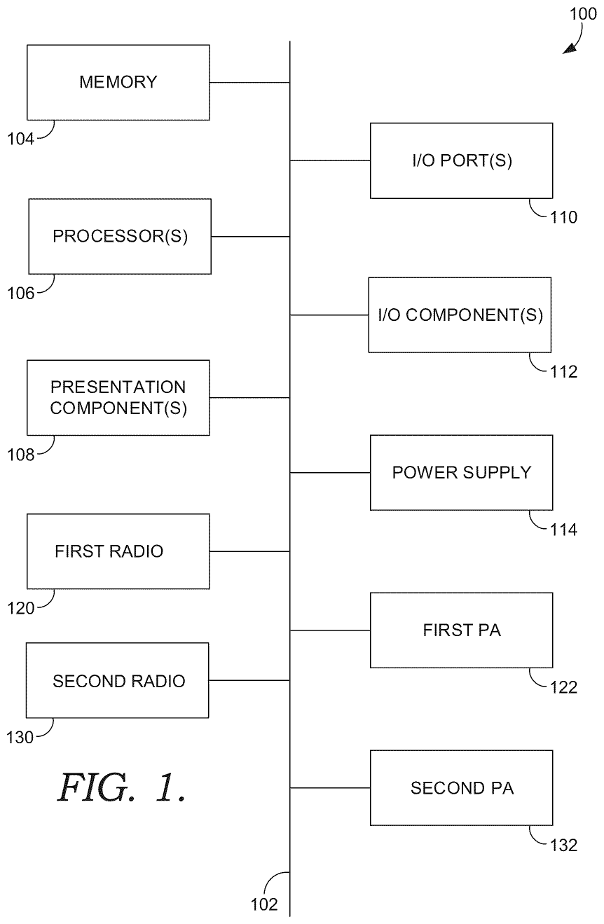

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) device (e.g., augmented reality (AR), virtual reality (VR), and mixed reality (MR)), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

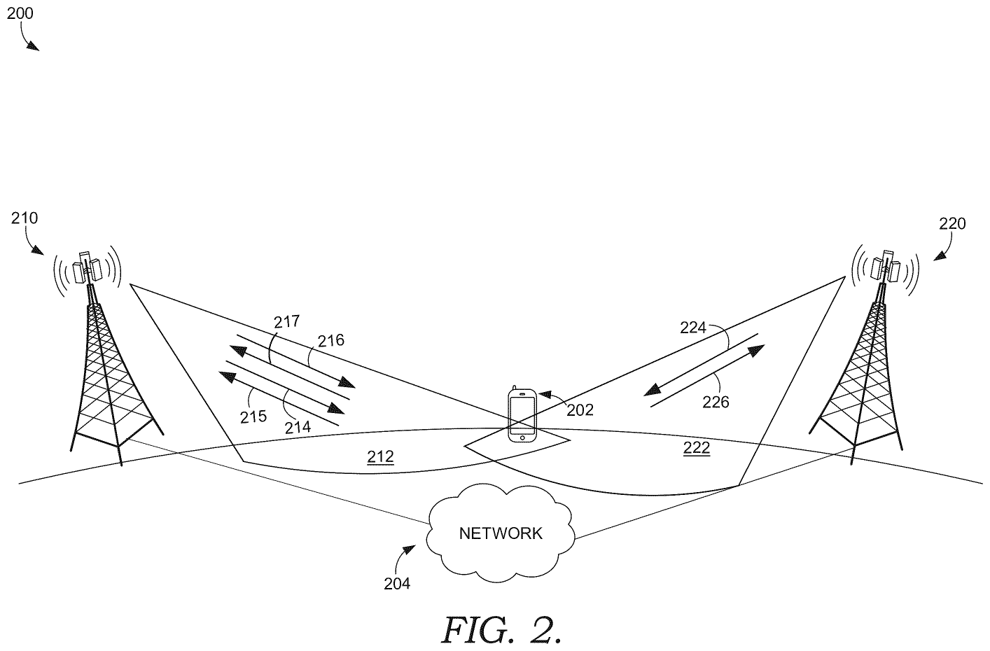

Turning now to FIG. 2, a representative network environment is illustrated in which implementations of the present disclosure may be employed. Such a network environment is illustrated and designated generally as network environment 200. At a high level the network environment 200 comprises a UE 202, a first base station 210, a second base station 220, and a network 204. It should be understood that more than one of each component is expressly conceived as being within the bounds of the present disclosure; for example, the network environment 200 may comprise additional base stations, additional UEs, and/or additional networks. Similarly, though certain objects of network environment 200 are illustrated in a certain form, it should be understood that they may take other forms; for example, even though the UE 202 is illustrated as a cellular phone, a UE suitable for implementations with the present disclosure may be any computing device having any one or more aspects described with respect to FIG. 1, and even though the first base station 210 and the second base station 220 are illustrated as macro cells mounted on towers, a base station suitable for use with the present disclosure may be terrestrial or extra-terrestrial (e.g., a satellite of a satellite radio access network) and may be of any scale desirable by a mobile network operator (MNO) (e.g., a small cell, pico cell, relay, and the like).

The network environment 200 includes one or more base stations, represented by the first base station 210 and the second base station 220. Each of the first base station 210 and the second base station 220 are connected to the network 204 (e.g., a MNO core network) and are configured to wirelessly communicate with one or more UEs, such as the UE 202. The first base station 210 is configured to transmit one or more component carriers in the downlink to a first coverage area 212 and to receive one or more component carriers in the uplink from a UE located within the first coverage area 212. As such, the first base station 210 may be configured to transmit a first downlink component carrier 214 and a second downlink component carrier 216, and to receive a first uplink component carrier 215 and a second uplink component carrier 217. In aspects, each of said component carriers may be characterized by their utilization of frequency domain duplexing (FDD) or time domain duplexing (TDD); for example, the first downlink component carrier 214 may be FDD and the second downlink component carrier 216 may be TDD (in another aspect, both may be FDD or both may be TDD). The second base station 220 may be similarly configured to transmit a third downlink component carrier 224 to a second coverage area 222 and receive a third uplink component carrier 226 from a UE located in the second coverage area 222. In aspects, each of the first downlink component carrier 214, the first uplink component carrier 215, the second downlink component carrier 216, and the second uplink component carrier 217 may be FDD signals, and each of the third downlink component carrier 224 and the third uplink component carrier 226 may be TDD signals. Though illustrated as having a single cell so as not to obfuscate the present disclosure, it should be understood that the first base station 210 may utilize a plurality of different cells to communicate signals to the UE 202; thus, in aspects, each of the first downlink component carrier 214 and the first uplink component carrier 215 are communicated between the UE 202 and a primary cell, each of the second downlink component carrier 216 and the second uplink component carrier 217 are communicated between the UE 202 and a first secondary cell, and each of the third downlink component carrier 224 and the third uplink component carrier 226 are communicated between the UE 202 and a second secondary cell.

The simultaneous (or near simultaneous) use of multiple component carriers is generally referred to as carrier aggregation, and may be utilized by the UE 202 in order, for example, to increase the amount of data that may be transmitted or received by the UE 202. The UE 202 comprises one or more components that, together, may be said to comprise a baseband processor, which handles tasks such as demodulation, decoding, error correction, and channel equalization. Relevant to the present disclosure, the UE 202 has a set of capabilities associated with what frequencies and bandwidths the UE 202 can process for each individual component carrier. The UE may also have a total number of component carriers it can process and a total aggregated bandwidth it can process across all component carriers.

The present disclosure relates to systems and methods for user equipment (UE) capability signaling in a wireless communication network, particularly for bandwidth combination set (BCS) signaling in the context of carrier aggregation (CA). Carrier aggregation allows the UE 202 to simultaneously utilize multiple component carriers (e.g., first downlink component carrier 214, the second downlink component carrier 216, and the third downlink component carrier 224) across one or more frequency bands, increasing data rates and improving network efficiency. However, not all networks and UEs support the same aggregation configurations, leading to compatibility issues when the UE 202 reports capabilities that are not recognized by a base station, such as the first base station 210 or the second base station 220.

One key aspect of CA capability signaling is the bandwidth combination set (BCS). A BCS defines specific sets of component carrier bandwidths and frequency bands that the UE can aggregate. Each BCS value corresponds to a predefined aggregation configuration that dictates which frequency bands and carrier bandwidths the UE may be allocated in a CA session. The network references the reported BCS index to determine valid carrier aggregation configurations when assigning frequency resources to the UE 202. Without proper BCS signaling, the network may be unable to configure CA effectively, leading to suboptimal spectrum utilization and reduced throughput.

BCS values are signaled by the UE 202 as part of a feature set, which groups various capability parameters together. A feature set defines the UE 202's supported CA configurations, including modulation schemes, multiple-input multiple-output (MIMO) layer support, maximum aggregated bandwidth, and power class settings. Each feature set typically contains one or more BCS values, which the network uses to determine supported CA configurations. Conventionally, the UE 202 reports its highest-order CA capabilities, which comprises the most up-to-date or highly capable BCS that the UE 202 supports with the most component carriers, and associated band combination capabilities. Band combination capabilities define the specific frequency bands and bandwidths that a UE can aggregate using CA.

Band combination capabilities indicate the UE 202's ability to aggregate either contiguous or non-contiguous component carriers. Intra-band contiguous carrier aggregation refers to contiguous carriers aggregated in the same operating band, whereas intra-band non-contiguous carrier aggregation refers to non-contiguous carriers aggregated within the same band. The notation used in band combination capabilities provides clarity regarding how carriers are aggregated. The “C” designation denotes intra-band contiguous carriers, where two aggregated component carriers within the same band are adjacent in frequency. The “A” designation denotes a single carrier, meaning that no additional component carriers in that band are aggregated. The “2A” designation signifies two non-contiguous component carriers within the same band that are aggregated in a non-adjacent manner. For example, a band combination such as CA_n25(2A)-n41C-n66(2A) indicates that the UE supports aggregating two non-contiguous component carriers in band n25, two contiguous component carriers in band n41, and two non-contiguous component carriers in band n66. As with the supported BCS, the UE 202 conventionally reports its highest order band combination capabilities, which inform the first base station 210 and/or the second base station 220 the upper limits of what the UE 202 supports. For example, the UE 202, when reporting its highest order capabilities would signal CA_n25(2A)-n41C-n66(2A) rather than CA_n25A-n41C-n66A (if the UE 202 supports CA_n25(2A)-n41C-n66(2A), then it must also support CA_n25(A)-n41C-n66(A)).

A higher-order band combination capability generally indicates that the UE 202 supports aggregating more frequency bands and wider bandwidths, leading to increased data throughput and more efficient spectrum utilization. By reporting fallback combinations and BCS values alongside its highest order combinations and BCS value, the UE 202 provides the network with alternative aggregation options in cases where the BCS value for the highest order combination is not supported by the first base station 210 or the second base station 220. The fallback combination and BCS signaling by the UE 202 may be persistent or may be transmitted in response to a trigger condition. Persistent fallback signaling refers to the continuous inclusion of fallback combinations and BCS values in UE capability reporting, regardless of network conditions. Alternatively, fallback combinations and BCS signaling may be triggered based on specific events that suggest potential compatibility issues. One example of a trigger condition is roaming-when the UE 202 connects to a new network that may not support the highest-order combination and BCS capability. In some cases, the act of roaming itself may trigger fallback signaling, while in other cases, the UE 202 may first evaluate whether the roaming network supports its highest-order combination and BCS before determining whether to signal fallback values. In other aspects, the trigger condition may be when the RAN explicitly indicates support for an older BCS than the UE's highest-order BCS. This may occur when the RAN signals a capability information message that does not include support for the UE's highest-order BCS, prompting the UE 202 to proactively report fallback values. In other aspects, fallback combination and BCS signaling may be triggered when the RAN does not provide any explicit BCS indication. If the RAN does not signal which BCS values it supports, the UE 202 may include fallback BCS values proactively to increase the likelihood of successful CA configuration. However, if the RAN explicitly signals support for the UE's highest-order BCS, the UE 202 may refrain from signaling fallback combinations and BCS values to reduce signaling overhead.

The fallback combinations and BCS values may be signaled using different approaches. In some embodiments, the UE 202 signals a single message comprising its highest-order band combination capabilities along with multiple BCS values, including the primary BCS and one or more fallback BCS values. For example, the UE 202 may report a list of supported band combinations such as CA_n25(2A)-n41C-n71(2A), CA_n25(2A)-n66(2A)-n71(2A), and CA_n25(2A)-n41C-n66(2A), where all band combinations share a primary BCS (e.g., BCS 5) and a fallback traditional BCS (e.g., BCS 0). Though today's device are likely to be capable of the most modern band combination and BCS values, the present disclosure may also be used by devices of any generation to report their highest order band combination and BCS (e.g., BCS 4) and also indicate older fallback band combinations and a BCS (e.g., BCS 0). In other embodiments, the UE 202 reports its highest-order band combination capabilities with the accompanying primary BCS value and separately signals fallback configurations, each comprising a band combination with a fallback BCS value which the network is more likely to support. For example, the UE 202 may separately signal a primary CA configuration (e.g., CA_n25(2A)-n41C-n66(2A) using BCS 5) and a fallback configuration (e.g., CA_n25A-n41C-n66A using BCS 4).

The UE may report multiple BCS values within a single feature set, in a separate fallback feature set, or in a dedicated message independent of feature set signaling (if the UE supports multiple BCSs). In some cases, the UE 202 may include both primary and fallback BCS values within the same feature set, allowing the RAN to select an appropriate configuration without requiring additional signaling. In other cases, the UE defines a separate fallback combination and feature set that is identical to the primary feature set except for the lower-order combination; in aspects, the fallback band combination capabilities reported in the fallback feature set may also be at least partially different than the band combination capabilities reported in the primary feature set. Additionally, the UE may transmit fallback band combinations and BCS signaling as an independent message that specifies fallback band combination capabilities without requiring a dedicated feature set for fallback BCS capability.

In some aspects, the fallback signaling is a strict subset of the primary signaling. For example, a fallback configuration of CA_n25A-n41C-n66A using BCS 4 may be considered a subset of CA_n25(2A)-n41C-n66(2A) using BCS 5, as the fallback configuration reduces the number of component carriers or bandwidths but remains within the original band combination capability; in other words, the fallback configuration may have the same or fewer bands as the primary (i.e., highest-order) signaling but with fewer component carriers. In other cases, fallback CA signaling may include band combination capabilities not present in the primary configuration. For instance, a primary configuration may specify CA_n25(2A)-n41C-n66(2A) using BCS 5, while a fallback CA configuration may specify CA_n25(2A)-n71(2A) using BCS 4.

The fallback CA configuration may include a number of component carriers that is less than or equal to the primary configuration. For example, if the primary configuration includes six component carriers (e.g., CA_n25(2A)-n41C-n66(2A) using BCS 5), then a fallback configuration may contain at most five component carriers.

The UE 202 may report either a single fallback or multiple fallbacks. In some cases, the UE signals a higher order combination with a relatively new BCS value (e.g., BCS 5) and a single fallback combination with a more well deployed BCS value (e.g., BCS 4). In other cases, the UE 202 signals multiple fallback BCS values for a given combination (e.g., BCS 5 as the primary and BCS 0 and/or BCS 1 as fallback options). In some embodiments, the fallback CA band combination is selected based on a fixed decrement pattern (e.g., the fallback combination always has one fewer component carrier than the primary BCS value). For example, if the highest order combination has 6 CCs, the fallback value may have 5 CCs. In other aspects, the fallback combination may comprise 2 or more fewer component carriers than the highest-order band combination. In some embodiments, the fallback CA capability comprises a BCS value that is different (one or more versions older than the primary BCS).

The fallback BCS signaling behavior of the UE may be dynamically updated over the air (OTA). For example, if the newer BCS value becomes universally supported across the network, the UE may be configured to discontinue fallback signaling to reduce unnecessary signaling overhead. Conversely, if network conditions suggest limited BCS compatibility across different RAN deployments, the UE may be programmed to increase the number of fallback band combinations and BCS values reported.

Although the present disclosure describes fallback BCS signaling in the context of cellular communication protocols (e.g., 4G/LTE, 5G/NR, 6G, and the like), similar concepts may be applied to other wireless technologies, such as multi-link optimization (MLO) in Wi-Fi. In such cases, fallback signaling may be used to provide alternative multi-carrier configurations to mitigate capability mismatches between a Wi-Fi access point and a station (Wi-Fi client device). For example, in a Wi-Fi MLO scenario, fallback signaling could allow a station, such as the UE 202, to report multiple supported link aggregation configurations, ensuring that the access point can select an alternative configuration if the preferred setup is not supported. Other protocols or communication standards may implement the present disclosure, as in Wi-Fi and cellular protocols, and no limitation to protocols presently utilizing or developing multi-carrier aggregation sessions is intended.

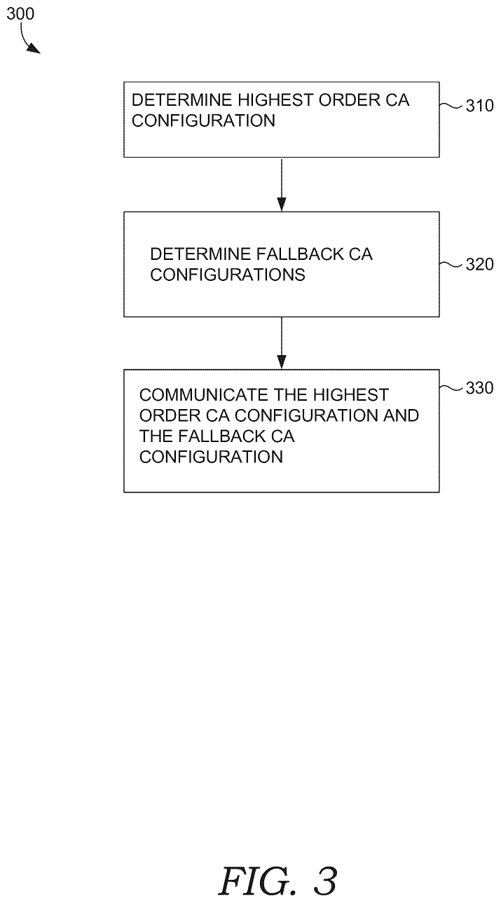

Turning now to FIG. 3, a flow chart is illustrated for signaling fallback bandwidth combination set values. At a first step 310, a UE such as the UE 202 of FIG. 2 determines its highest order carrier aggregation configuration and bandwidth combination set value, according to any one or more aspects described herein. At a second step 320, the UE determines one or more fallback carrier aggregation configurations, wherein each of the one or more fallback carrier aggregation configurations has a bandwidth combination set value that is different than the highest order bandwidth combination set value, according to any one or more aspects described herein. At a third step 330, the UE communicates both the highest order carrier aggregation configuration and at least one of the one or more fallback carrier aggregation configurations to a node of a radio access network according to any one or more aspects described herein.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for signaling carrier aggregation capabilities in a wireless communication network, the method comprising:
determining, by a UE, that a trigger condition for signaling one or more fallback bandwidth combination set (BCS) parameters is satisfied; and
responsive to determining that the trigger condition is satisfied, transmitting, by the UE, a primary capability message and a fallback capability message, wherein the primary capability message comprises one or more primary band combination capabilities and a primary BCS value, and wherein the fallback capability message comprises one or more fallback band combination capabilities and a fallback BCS value, the primary band combination capabilities being different than the fallback band combination capabilities and the primary BCS value being different than the fallback BCS value.

2. The method of claim 1, wherein the primary BCS value indicates a highest-order BCS capability of the UE.

3. The method of claim 1, wherein the fallback capability message comprises one or more fallback BCS values that are lower than the primary BCS value.

4. The method of claim 1, wherein the trigger condition comprises a determination that the UE is roaming.

5. The method of claim 1, wherein the trigger condition comprises the UE receiving an indication that the base station does not support the highest-order BCS value.

6. The method of claim 1, wherein the trigger condition comprises the UE failing to receive a BCS indication from the base station.

7. The method of claim 1, wherein the fallback capability message is included in a feature set that is identical to the primary feature set except for the BCS value.

8. The method of claim 1, wherein the fallback capability message is transmitted as an independent message that is not associated with a feature set.

9. The method of claim 1, wherein the fallback BCS values are determined based on a decrement pattern relative to the primary BCS value.

10. The method of claim 1, wherein the fallback band combination capabilities comprise a reduced number of component carriers compared to the band combination capabilities associated with the primary BCS value.

11. The method of claim 1, wherein the fallback band combination capabilities comprise a different set of frequency bands than those associated with the primary BCS value.

12. The method of claim 1, wherein the UE transmits multiple fallback capability messages, each corresponding to a different fallback BCS value.

13. The method of claim 1, wherein the fallback capability message comprises the primary and fallback BCS values within the same message.

14. The method of claim 1, wherein the fallback capability message is transmitted in a separate message from the primary BCS value.

15. The method of claim 14, wherein the separate message comprises a first feature set message including the primary BCS value and a second message including the fallback BCS value without a feature set.

16. The method of claim 14, wherein the separate message comprises a second feature set, wherein the second feature set comprises the fallback BCS value.

17. A method for signaling carrier aggregation capabilities in a wireless communication network, the method comprising:
determining a maximum resource block baseband processing capability of the UE;
reporting a primary carrier aggregation capability having a first set of band combinations and a first bandwidth combination set (BCS) value; and
reporting at least one fallback carrier aggregation capability, wherein the at least one fallback carrier aggregation capability comprises a second BCS value, the second BCS value being different than the first bandwidth combination set value.

18. The method of claim 17, wherein the fallback capability message is included within the same feature set as the primary BCS value.

19. The method of claim 17, wherein the fallback capability message is transmitted as a separate message independent of feature sets.

20. A system for or communicating with a wireless base station, the system comprising:
one or more antennas; and
one or more computer processing components configured to perform operations comprising:
transmitting, via the one or more antennas, a highest-order bandwidth combination set (BCS) value;
transmitting, via the one or more antennas, at least one band combination capability; and
transmitting, via the one or more antennas, a fallback BCS value, wherein the fallback BCS value is different than the primary BCS value.
